(19) United States
(12) Patent Application Publication
(10) Pub. No.: US 2002/0141179 A1
(43) Pub. Date: Oct. 3, 2002

(54) Ornamental water light

(76) Inventor: Jen-Yen Yen, Changhua Hsien (TW)

Correspondence Address: Alan Kamrath, RIDER BENNETT EGAN & ARUNDEL, LLP, 333 South Seventh Street, Suite 2000, Minneapolis, MN, 55402, US

(21) Appl. No.: 09/821,242

(22) Filed: Mar. 29, 2001

(51) Int. Cl. F21V 33/00

(52) U.S. Cl. 362/96; 362/101; 362/806

(57) ABSTRACT

The ornamental water light has an inner tube, an outer tube communicating with the inner tube and having therein water, a spiral pathway securely clamped between the inner tube and the outer tube and hollow balls movable inside the inner tube and between the inner tube and the outer tube. When the water light is operating, the bubbles from the bubble generator cause an upward current inside the inner tube and a resultant downward current in the space between the inner and outer tubes. Consequently, the hollow balls float upward in the inner tube and downward along the bottom face of the spiral pathway between the inner and outer tubes. The movement of the bubbles and hollow balls creates an ornamental and entertaining effect for the observer.

### BACKGROUND OF THE INVENTION

1. Field of the Invention

The present invention relates to an ornamental water light, and more particularly to a water light having a spiral pathway securely clamped between an inner tube and an outer tube and multiple hollow balls movably received in the outer tube.

2. Description of Related Art

A water light normally is used to improve the indoor ambiance by providing a soothing environment for the occupants. With reference to FIGS. 2, a conventional ornamental water light (10) has a transparent tube (11) with water inside the tube (11) and plastic flowers (12) securely attached to the bottom of the tube (11). A soft light source (not shown) normally is provided in the bottom of the tube (11). When the water light is on, the leaves or flower buds of the flowers (12) reflect the light source and emit various colors due to the flowing of the water.

With reference to FIG. 3, another type of conventional water light (20) also has a transparent tube (21) with water, multiple colored marbles (22) and bubbles (23) generated in the water. With the light source (not shown) in the base (24), the bubbles (23) and the colored marbles (22), the colored marbles (22) serve as colored filters, and the bubbles (23) reflect and radiate the color of the light source transmitted through a particular colored marble (22). The foregoing water lights are too dull and do not show any change vividly. To overcome the drawbacks of the conventional water lights, a water light (30) shown in Fig. FIG. 4 has inclined plates (31) separated from each other and a bubble generator (32) provided on a bottom of a transparent tube (33). The bubble generator (32) has an outlet adjacent to one of the inclined plates (31), so that when a bubble (34) is generated by the bubble generator (32), the bubble (34) moves along a bottom face of each of the inclined plates (31). Because the inclined plates (31) are separated from each other and the water pressure is gradually decreasing, the shape of the bubble (34) constantly changes during its movement up to the top portion of the tube (33), which does provide a different aesthetic effect to the user.

With reference to the water lights with bubbles, the movement of the bubble is in a single direction, which is quite boring and not decorative enough to provide the required effect.

To overcome the shortcomings, the present invention intends to provide an improved ornamental water light to mitigate and obviate the aforementioned problems.

### SUMMARY OF THE INVENTION

The primary objective of the invention is to provide a water light having movement up and down inside a transparent tube to provide not only a soothing effect but also an entertainment effect to the user.

Another objective of the invention is to provide a spiral pathway between an inner tube and an outer tube, such that hollow balls will be guided by the pathway during their movement to the bottom of the outer tube.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the ornamental water light in accordance with the present invention;

FIG. 1A is an exploded perspective view of the ornamental water light in accordance with the present invention;

FIG. 2 is a perspective view of a conventional water light;

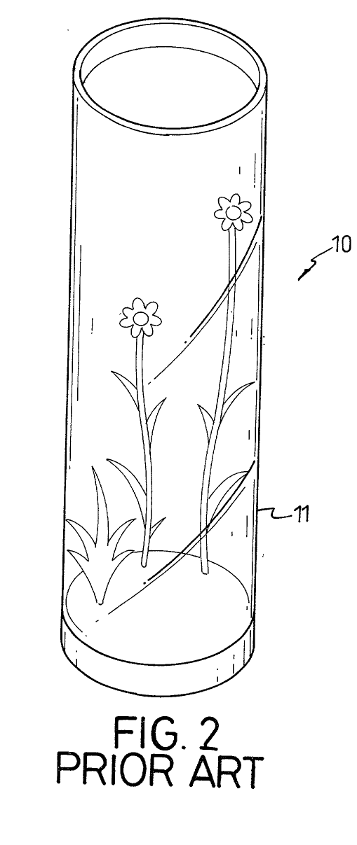

FIG. 3 is a side plan view in partial section of another conventional water light; and

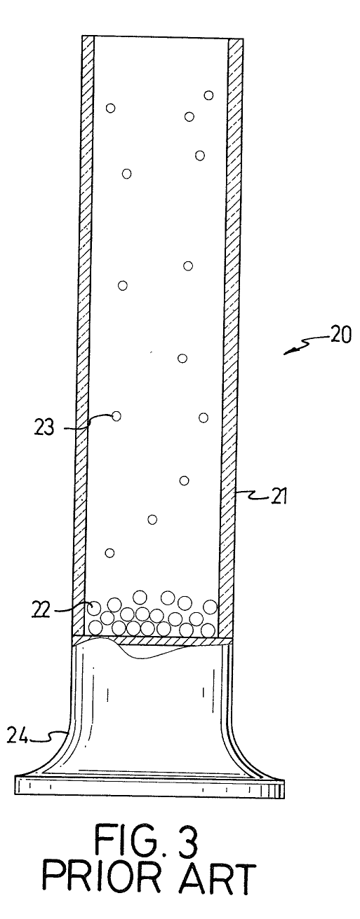

FIG. 4 is a side view in partial section of still another conventional water light.

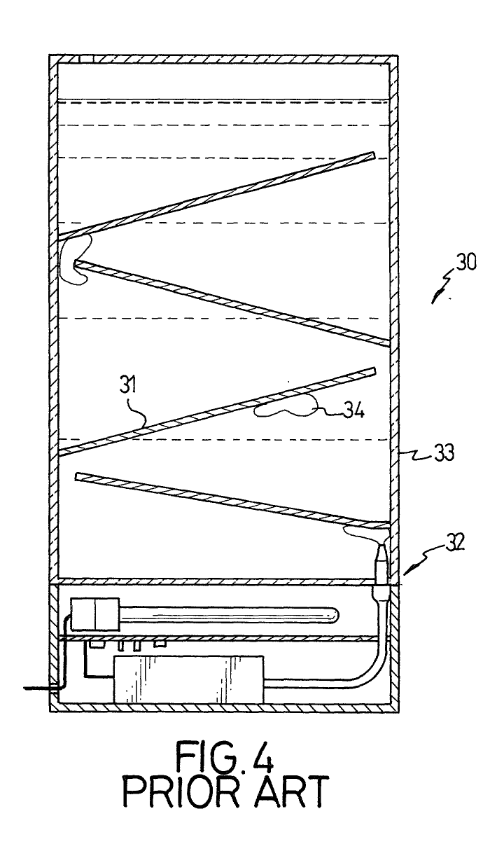

### DETAILED DESCRIPTION OF PREFERRED EMBODIMENT

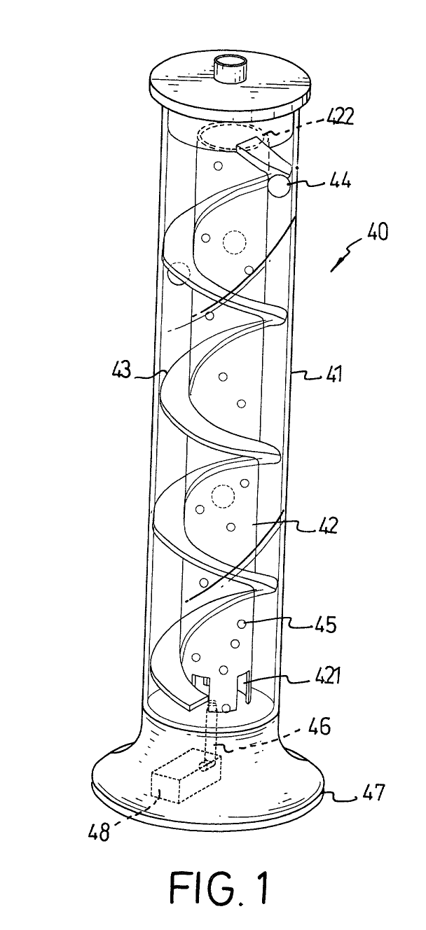

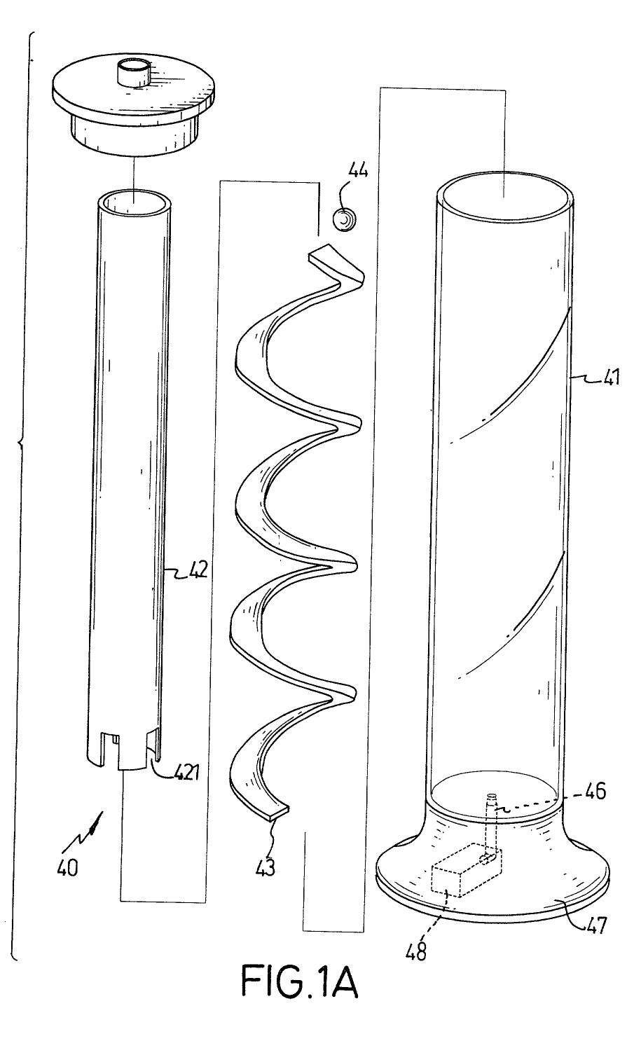

With reference to FIGS. 1 and 1A, the water light (40) in accordance with the present invention has a transparent outer tube (41), an inner tube (42), a spiral pathway (43) and a base (47). The spiral pathway (43) has a top and bottom face and is securely clamped between the outer tube (41) and the inner tube (42). The base (47) supports the inner and outer tubes (41,42) and has a light source (48).

The outer tube (41) and the inner tube (42) have a top and a bottom and are full of water. A bubble generator (46) is mounted at the bottom of the inner tube (42) to provide bubbles (45) in the inner tube (42). Furthermore, hollow balls (44) are movably received between the inner tube (42) and outer tube (41) and inside the inner tube (42). That is, the inner tube (42) has cutouts (421) defined in the bottom portion adjacent to a joint between the inner tube (42) and the bottom of the outer tube (41).

When the ornamental water light is operating, the bubble generator (46) inside the inner tube (42) generates bubbles (45). The bubbles (45) which rise to the top of the inner tube (42) generates a water current inside the inner tube (42) from the bottom to the top of the inner tube (42). When the water inside the inner tube (42) flows, the hollow balls (44) are driven to the top of the inner tube (42) by the current. Because the top of the inner tube (42) is an opening (422) below the top of the outer tube (41), the upward water current in the inner tube (42) is directed outward and downward into the outer tube (41) as it passes through the opening (422). The hollow balls (44) are driven out of the inner tube (42) by the water current and into the space between the inner and outer tubes (41, 42). Due to the buoyancy of the hollow balls (44), the hollow balls (44) will float along the bottom face of the spiral pathway (43) and are forced downward by the current to the bottom of the outer tube (41). Because the direction of the water current causes the water to flow into the inner tube (42) through the cutouts (421), the hollow balls (44) are also forced into the inner tube (42) through the cutouts (421). After the hollow balls (44) are inside the inner tube (42), the hollow balls (44) are again forced by the water current inside the inner tube (42) to flow to the opening (422) in the inner tube (42), the cycle continues.

During the operation of the water light, the downward movement of the hollow balls (44) and the upward movement of both the bubbles (45) and the hollow balls (44) create a decorative and entertaining effect for the observer.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A water light comprising:
a base having therein a bubble generator to generate bubbles and a light source; an outer tube securely mounted on the base and having water received inside the outer tube;
an inner tube securely received in the outer tube and having an opening defined in a top portion of the inner tube to communicate with the outer tube and cutouts defined in a bottom portion of the inner tube to communicate with the outer tube;
a spiral pathway securely clamped between the inner tube and the outer tube;
hollow balls movably received inside the inner tube and between the inner tube and the outer tube; wherein the balls are freely movable inside the inner tube and are moved along a bottom face of the spiral pathway by a water current; and
the bubble generator is received inside the base for generating bubbles inside the inner tube.
